(19) United States
(12) Patent Application Publication
(10) Pub. No.: US 2014/0257152 A1
(43) Pub. Date: Sep. 11, 2014

(54) METHODS FOR THE INTEGRATED TREATMENT OF NEUROMUSCULOSKELETAL INJURIES AND CONDITIONS

(71) Applicant: Pointway, Inc., Minnetonka, MN (US)

(72) Inventor: Josh J. Sandell, Maple Grove, MN (US)

(21) Appl. No.: 13/785,397

(22) Filed: Mar. 5, 2013

(51) Int. Cl. A61H 7/00

(52) U.S. Cl. CPC A61H 7/002
USPC 601/134

(57) ABSTRACT

The present invention provides a method and a system that treats Neuromusculoskeletal conditions and/or injuries in an integrated and structured manner. Such conditions and/or injuries are not one-dimensional in origin, severity or persistence; they are multi-factorial. The present invention treats the conditions and/or injuries in a multi-disciplinary and structured sequence in order to maximize the efficacy of the treatment which results in a shorter period of treatment, fewer office visits and treatments, lower cost and increased patient satisfaction. More specifically, various embodiments of the present invention comprise a sequential treatment comprising transverse frictional massage, mobilization clearances, decreasing active stiffness and decreasing passive stiffness of the over-facilitated tissues, increasing active and passive stiffness of the inhibited tissues followed by neuromuscular re-education.

### RELATED APPLICATION

None

### BACKGROUND OF THE INVENTION

1. Field of the Invention

The invention relates generally to methods for treating injuries and/or conditions of the neuromusculoskeletal system.

2. Description of the Related Art

Generally, treatment of injuries and/or conditions of the neuromusculoskeletal system, defined as comprising the nerves, muscles and bones of a patient, have been treated by healthcare providers in fields or disciplines that focus on one or more components of the injury or condition.

For example, healthcare providers currently treating a lower back injury may include chiropractic doctors, physical therapists, orthopedic physician, physiatrists, massage therapists, and the primary care physician. Each of these disciplines focus on different elements of the musculoskeletal system in treating the exemplary lower back injury.

Chiropractic health care treatment addresses a wide variety of disease processes and neuromusculoskeletal conditions. Often focusing on correcting subluxations through a variety of manipulation techniques, chiropractic is essentially a functional discipline that may influence biomechanical and neural integrity. The typical chiropractic treatment plan will generally consider the following elements: adjustments, joint mobilization, ultra-sound treatment, low-level laser therapy, traction, flexion-distraction treatment, massage and simple rehabilitation. Often, correction of subluxations requires a lengthy treatment plan consisting of regularly scheduled adjustments for months at a time. In addition, patients are sometimes required to perform exercises at home. Patients' long term success is predicated on active exercises done at home. Poor compliance by patients in fulfilling these home-based exercises results in extending the treatment plan, with accompanying cost.

In contrast, a physical therapy plan may include assessment and management of movement dysfunction and enhancement of physical and functional abilities. The physical therapist thus focuses on restoration, maintenance and promotion of optimal physical function in addition to optimal wellness, fitness and optimal quality of life as it relates to movement and health. Thus, the physical therapist treatment plan typically includes consideration of the following elements: recommendation of, or assistance with, specific exercises, manual therapy, education, manipulation and other similar interventions. In addition, physical therapy treatment plans can be preventive in that physical therapists may work with the patient to prevent loss of mobility before it occurs by ensuring maintenance of maximum movement and functional ability where movement and function may be threatened by aging, injury, disease and/or environmental factors. Thus, for the physical therapist, functional movement is central to what it means to be healthy.

As with the chiropractic treatment plan, however, the physical therapy plan typically requires a series of regularly scheduled treatments which can go on for months at a high cost over the course of treatment and is often instituted anachronistically.

An orthopedic doctor may be consulted for the exemplary lower back injury as well. The orthopedist is a physician specializing in the diagnosis and treatment of part of the musculoskeletal system, consisting of bones, joints, ligaments and tendons. Thus, the orthopedist focuses on treating a subset of the larger neuromusculoskeletal system. Typical orthopedic diagnoses and treatment plans may include physical exams and imaging technology, e.g., X-rays and MRI's in conjunction with medication, physical therapy, and/or surgery.

Primary care physicians (PCP) assist patients in maintaining overall health by focusing on preventive care as well as symptom-based care. Some, but not all, insurance companies require patients to choose a PCP. PCP's may work with non-emergency maladies such as minor sports injuries and the like. In the exemplary lower back condition the PCP may conduct a physical exam and establish a treatment plan that may include pain medication, reduction in patient activities and the like, with possible subsequent referral to a physical therapist and/or orthopedist.

The engagement of the current healthcare services, such as those discussed supra, for lower back conditions, has increased substantially over the past two decades. Several studies have identified greater use of spinal injections, opioid medications and surgery. In addition, lower back conditions result in increases in medication prescriptions as well as numbers of visits to physicians, physical therapists and chiropractors.

Moreover, there is no evidence that spinal manipulative therapy alone, typically provided a patient with lower back pain by the typical chiropractic treatment plan, is superior to other standard treatments, e.g., by physicians and physical therapists.

Similarly, there is evidence of low efficacy of exercise therapy provided by physical therapists in the treatment of the exemplary low back condition, with exercise treatment being only slightly effective at decreasing pain and improving function in adults with the pain associated with a low back condition.

Finally, orthopedic treatment often comprises spinal injections, opioid medications and surgery. Clearly, except in the most necessary cases, patients with the exemplary low back condition should not be exposed to invasive, highly expensive and potentially dangerous treatments such as surgery or spinal injections. Further, potentially addictive medications to treat the pain rather than the underlying conditions appear counterproductive in that they are potentially dangerous in both masking the pain which may result in the patient doing things that may cause further injury as well as risking possible addiction.

It is the case that the type of care a patient receives is highly dependent upon and correlated with the initial type of healthcare provider the patient sees first. For example, the patient who sees an orthopedic surgeon first will be much more likely to undergo surgery than a patient that sees a physical therapist or chiropractor first. As outlined briefly above, results from surgical interventions are sub-optimal in many cases and unnecessary, not to mention highly expensive compared with other treatment options.

Compounding the above, the patient often moves from one healthcare provider, e.g., PCP, chiropractor, physical therapist, orthopedist/surgeon in order to obtain relief. If a non-surgical, effective treatment method were available for the patient in the first instance, much time, expense and pain would be saved.

A typical patient with the above-referenced exemplary low back condition may begin addressing the problem by seeing his or her PCP who then may refer the patient to an orthopedist. The orthopedist may refer the patient on to a back specialist or an orthopedic surgeon who may conduct surgical intervention to correct the problem. In conjunction with these activities, the patient may also be referred to a neurologist who may refer the patient on to a pain specialist to assist in dealing with the associated pain issues. In addition, and from the beginning of the entire treatment process, the patient may also be visiting a chiropractor and a physical therapist.

It is clear that none of the treatment methods or systems arising from the most common healthcare disciplines that currently treat neuromusculoskeletal conditions or injuries comprise an integrated and structured approach to treating injuries and/or conditions of the neuromusculoskeletal system as an integrative whole.

### BRIEF SUMMARY OF THE INVENTION

The present invention provides a method and a system that treats neuromusculoskeletal conditions and/or injuries in an integrated and systematized manner. Such conditions and/or injuries are not one-dimensional in origin, severity or persistence; they are multi-factorial. The present invention treats the conditions and/or injuries in a multi-disciplinary and structured sequence in order to maximize the efficacy of the treatment which results in a shorter period of treatment, fewer office visits and treatments, lower cost, improved long-term outcomes and increased patient satisfaction. More specifically, various embodiments of the present invention comprise a sequential treatment comprising transverse frictional massage, mobilization clearances, decreasing active stiffness and decreasing passive stiffness of the over-facilitated tissues, increasing active and passive stiffness of the inhibited tissues followed by neuromuscular re-education, and finally reinforcement utilizing compound multiplanar movements.

The figures and the detailed description which follow more particularly exemplify these and other embodiments of the invention.

### BRIEF DESCRIPTION OF THE DRAWINGS

FIG. 1 provides a flowchart of one embodiment of the present invention;

FIG. 2 provides a flowchart of one embodiment of the present invention;

FIG. 3 provides a flowchart of one embodiment of the present invention;

FIG. 4 provides a flowchart of one embodiment of the present invention.

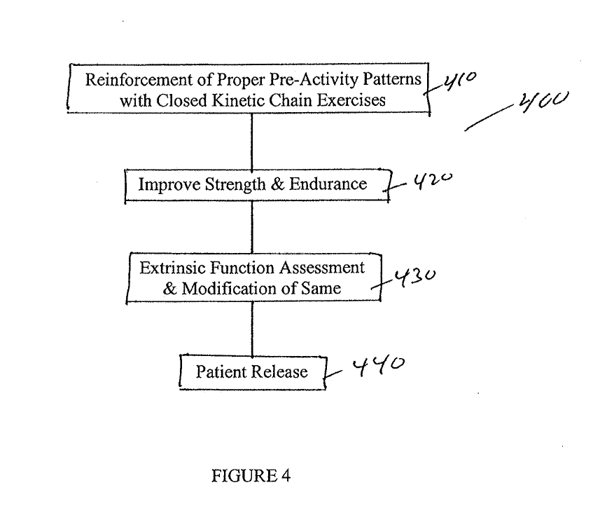

The invention may be more completely understood in consideration of the following detailed description of various embodiments of the invention in connection with the accompanying drawings, which are as follows.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

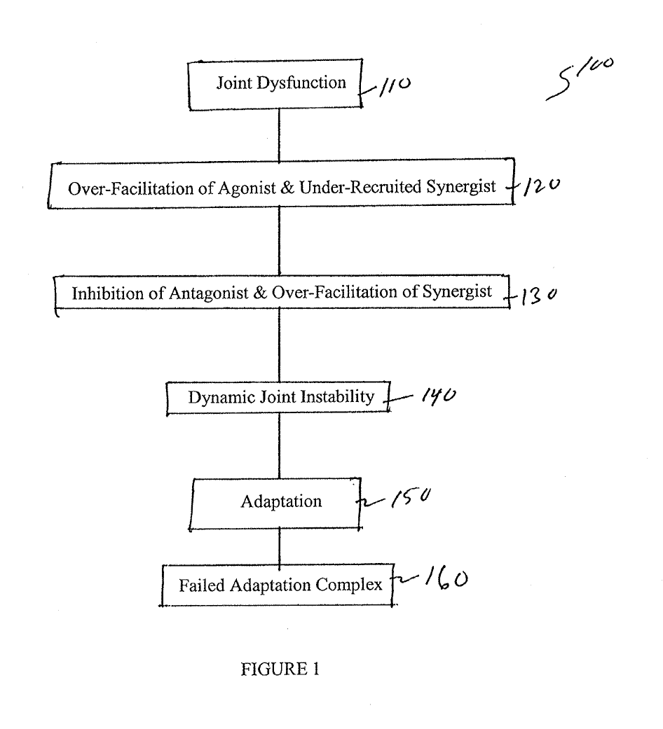

FIG. 1 provides a general flowchart of a condition and/or injury of the neuromusculoskeletal system that is amenable to treatment using the present invention. Accordingly, exemplary injury and/or condition process 100 begins with a joint dysfunction 110 which is followed by over-facilitation of agonist tissue and under-recruited or inhibited synergist tissue 120. Reaction to step 120 comprises inhibition of antagonist tissue and over-facilitation of synergist 130. This may result, in turn, in dynamic joint instability 140 and connective tissue adaptation 150 by the patient. Ultimately, a failed adaptation complex 160 results, for example, injuries and/or conditions of the neuromusculoskeletal system that may comprise tendinopathy, osteoarthritis, fasciosis, tissue degradation, etc.

The joint dysfunction 10 leading to failed adaptation complex 60 of process 100 may manifest in pain. The most common areas such pain is manifested include: lower back, shoulder, knee, ankle and hip, though the skilled artisan will recognize a number of additional areas such as, e.g., the elbow or neck, that cause pain under the process 100 of FIG. 1.

Initially, each healthcare provider will follow essentially the same protocol in obtaining the patient's medical and other relevant history as well as conducting a physical examination which will include an inspection

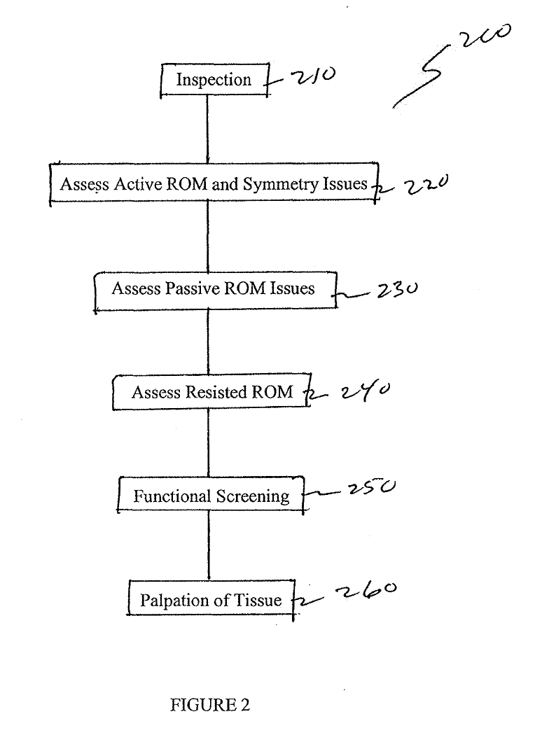

Turning now to FIG. 2, the assessment process 200 is illustrated. Thus, general visual and physical inspection 210 is conducted of the patient. The goal of inspection 210 is to take in a global static joint stress picture of the patient, with focus of observations on notable imbalances and force asymmetries across articulations. Thus, conditions that are relevant may include antalgia, asymmetry, and postural issues are evaluated. Further, other visuals are evaluated and noted, e.g., effusion, edema and/or bruising, erythema, and petechial to mention a few of the relevant conditions to the inspection 210.

Next, the provider assesses the patient's active range of motion (ROM) and symmetry issues 220. Here, the provider assesses, in functional patterns as are well known in the art, motion, symmetry and pain, noting inter alia, any differentials between inert and contractile movements.

The provider then assesses any passive ROM issues in the patient in step 230. These assessments are performed in coupled patterns and diagonals, searching specific planes of resistance and testing intersegmental motion as is well known in the art. In addition, the provider is assessing type of end-feel, e.g., capsular, bony, effusion, muscle, empty end-feel types. The provider further notes areas of passive tension during this inspectional phase as well as evaluates accessory motions and joint integrity, e.g., roll, spin, and glide quality as the skilled artisan will readily understand.

The inspectional process 200 then moves into assessment of resisted ROM in step 240 where the provider may focus on specific muscle(s) generally and/or muscle(s) that are sport or activity specific and potentially identify weaknesses therein.

The functional screening step 250 assesses the patient's gait and includes an upper body evaluation, lower body evaluation and overall global system evaluations. Examples of upper body evaluation tools comprise scapular movement range and the plank. Lower body evaluation exemplary tools comprise the patient performing one or more squats, single-leg hop, depth jump, Y-excursion test and the like. Finally, examples of a global system evaluation may include techniques like running, proprioception, quadruped movement and the like.

The inspectional process 200 concludes with palpation of tissue 260 as informed by the results of the preceding inspectional steps 210-250. Thus, the provider palpates subject tissue of the patient to assess its tone, e.g., hypertonicity, flaccidity, its texture, e.g., fibrotic, ropy, extensile, its tenderness and for decreased muscle length.

In addition to the inspectional process 200, certain orthopedic and other specialized tests may be conducted (not illustrated) in order to provide further information about the specific neuromusculoskeletal condition and/or injury. These test can include, e.g., neurologic testing and/or sports-specific testing in order to better understand the injury and/or condition.

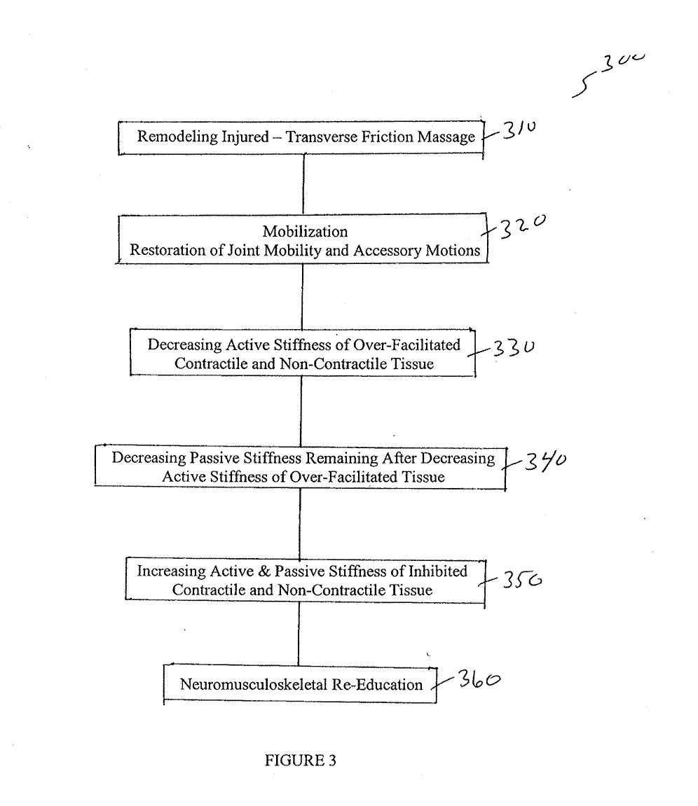

Once the inspection process 200 is completed, the passive care phase 300 of the treatment may begin as illustrated in FIG. 3.

The passive care phase 300 begins with remodeling the injured tissue through transverse friction massage 310. Transverse friction massage (TFM) is applied in the present invention perpendicular to length of the organized fibers, i.e., in the direction of resistance to unorganized tissue. Applicant has found through experimentation that very firm pressure applied for a time period ranging from 8 to 15 minutes, or more preferably, from 10-15 minutes, is optimal. The massage is conducted with a firmness and at a resulting depth within the tissue specific to the condition and/or injury, so that all fibers of the specific tissue are massaged.

The provider must look to four key areas for palpation and subsequent provision of TFM: (1) the musculotendinous junction; (2) the tenoperiosteal junction; (3) the muscle belly; and (4) the different classifications of fascia i.e. linking, fascicular, compression separating fascia.

Following the initial TFM treatment, a re-evaluation of the inured tissue is conducted, seeking additional diagnostic and/or confirmation of initial diagnosis data. Patients may experience soreness in the area subjected to the TFM for 1-2 days following the procedure.

Some exemplary neuromusculoskeletal conditions and/or injuries are provided below, with palpable components to assess for treatment with TFM:

Low-Back Pain

### Supraspinous Ligaments;

### Multifidus mm;

Iliocostalis lumborum;
Quadratus lumborum;

### Dorsal SI Ligaments;

### Superficial Erector Spinae;

### Piriformis;

### Gluteus Maximus/Med;

### Sacrotuberous Ligaments;

### Proximal Hamstrings; and

### Iliopsoas mm.

Shoulder Pain

### Suprinatus;

### Infraspinatus;

### Subscapularis;

### Teres Minor;

### AC Ligaments;

### Latissimus Dorsi;

### Trapezius;

### Rhomboid(s);

### Pectoralis Major/Minor;

Biceps (long head) Tendon;

### Anterior and Posterior Shoulder Capsule; and

### Cervical Components

Knee Pain

### Retinaculum;

### Quad Tendon;

### Patellar Tendon;

### Patellofemoral Ligament;

### Supra/Infra Patellar Pouch;

### MCL, LCL;

### IT Band Insertion(s);

### Hamstring Insertions;

### Quad Insertions;

### Calf Origins;

### Popliteus;

### A/P Knee Capsule; and

### Hip and Ankle Components.

Ankle Pain

### Achilles Tendon;

### Gastrocnemius & Soleus;

### Posterior Tibialis;

### Deltoid Ligament;

### Anterior Talofibular Ligament;

### Posterior Talofibular Ligament;

### Calcaneofibular Ligament;

### Tibiofibular Ligaments;

### Anterior Tibialis;

### Peroneii mm;

### Tibiofibular Syndesmosis; and

### Hip and Knee Components.

Hip Pain

### Iliopsoas mm;

### Rectus Femoris & Proximal Quadriceps;

### Sartorius;

### Gluteus Medial/Maximus;

### Piriformis;

### Anterior/Posterior Hip Capsule;

### Tensor Fascia Lata;

### IT Band;

### Adductors;

### Pectineus;

### Proximal Hamstrings;

### Sacrotuberous Ligament;

### Dorsal SI Ligament; and

### Ischiofemoral Ligament.

Following the TFM process 310, a mobilization of the affected joint(s) is performed 320, the goal being restoration of joint mobility and accessory motions such as roll, spin and glide; a “clearing” of any restrictions of the joint. Mobilization of the joint is a procedure typically performed by chiropractors and occasionally physical therapists and involves moving the elements of the joint throughout a range of motion. It is critical to the inventive process that, if a hard end feel, i.e., a stoppage in motion, at any point during the mobilization, any joint restriction must be cleared before proceeding. Joint mobilization 320 is specific to the movement and the plane of restriction with loss of motion assessed by all of the joint's accessory motions as will be well understood by the skilled artisan, e.g., physical therapists and chiropractors.

Following mobilization 320, the provider works to decrease active stiffness in contractile tissues that are understood through the inspection process 200 as being over-facilitated in order to release specific “tight areas” in order to restore normal motion 330. Over-facilitated muscle typically produces a “fascial burn” as noted by the patient when the practitioner utilizes the method trained in palpating the area of increased tissue tension. In this process step the active “overfacilitated” tissue is decreased and there is a decrease in motor pool excitability.

Step 330 proceeds with therapeutic procedures comprising an isometric contraction for a period of time, e.g., 5 to 15 seconds, at the eccentric end range. This is followed by an active antagonist contraction in to a new end range with assistance by the provider. The contraction is held at the new end range while the patient resists opposing force provided by the provider for a time period, e.g., 5 to 15 seconds. This process is repeated during the in-office session several, e.g., 2-3 times, with instructions to the patient to continue to perform this process at home as often as necessary to achieve maximum potential strength.

Next, as shown in step 340, the provider works to decrease any passive stiffness remaining after the decreasing the active stiffness of over-facilitated tissue process step in 330. In this instance, the therapeutic procedure comprises applying sustained firm pressure over the shortened inert tissue with movement into the restricted plane whereby the patient feels or notes a “melting” away of the tissue as it releases.

In addition, the provider also works to increase passive stiffness of inhibited tissue, both contractile and non-contractile, in step 350. Here, the opposing tissues lacking stiffness or excitability are the therapeutic target. Contraction while additionally receiving perturbations is then used to wake up the inhibited musculature with deep strokes along the muscle. This process excites the intrafusal muscle fibers and, subsequently, the muscle's reflexology. Further excitation of the motor neuron pool or system of the patient will be achieved with moderate contractions of the subject muscle(s) against resistance while receiving short, quick and deep stroke perturbations to the same muscle(s). A summating “fascia burn” will be noted by the patient with an increasing intensity.

Steps 330, 340 and 350 comprises therapeutic procedures that work together to achieve a balance between the over-facilitated and the inhibited tissues and may be referred to collectively as “facilitation”. Both types of dysfunctional tissues are prone to injury. Steps 330, 340 and 350 thus work to being the dysfunctional tissues into a balance to minimize and/or prevent future injuries from occurring and to prevent a relapse into the antecedent pattern that caused the original injury and/or condition.

The final step in the passive care process 300 is that of Neuromusculoskeletal re-education at the cortical, sub-cortical and spinal levels 360. One goal of this step is to increase the electrical activity of the previously inhibited musculature as measured by electromyography or EMG. Another goal is to reinforce those previously missing patterns that are the essence of co-contraction by priming the associated motor neuron pool or system. Specifically, in the range of most restriction and/or weakness, the patient will use isotonic contraction from the beginning of the eccentric range to the end of the eccentric range. The patient will next resist a counteractive movement of eccentric lengthening whereupon a perturbation will be delivered to the muscle(s) by the provider. This process is repeated several times and will, over time, result in the patient learning to consciously co-contract to stabilize the previously vulnerable or lost range of motion isometrically against all angles of perturbations.

The active care process 400 then follows the passive care process 300. The active care process 400 begins with reinforcement of proper pre-activation patterns with closed kinetic chain exercises as are well understood by the skilled artisan. Step 420 proceeds with improvements in both strength and endurance. In both steps 410 and 420 patients are provided with exercise regimens that aid in treatment and recovery from the patient's specific injury and/or condition. In addition, an extrinsic factor assessment is conducted with recommended modifications of same in 430. Elements such as, e.g., footwear, activity technique classes, bicycle setup and the like may be assessed in 430 in order to eliminate, or accommodate, an extrinsic cause for joint dysfunction. A particular example may be to identify the patient as a pronator with a flat foot, with recommendation to begin using a motion control shoe.

Ultimately, the goal is efficient and timely release of the patient 440 with correction of the patient's original injury and/or condition. This inventive method and system is achieved through a single provider facility and without invasive or surgical intervention.

In addition, my invention has proven to shorten the numbers of treatment visits and improve long-term outcomes, as compared with the usual treatment options provided by the healthcare providers and disciplines discussed supra. Ultimately, the present invention shortens the time to recovery, allowing the patient to return to work and other activities in a shortened time frame compared with known and typical treatment options.

### Working Example 1

Working example for typical “tight” pectoral bench presser shoulder issue

Remodeling Injured Tissue—Step 310

1. Palpatory findings reveal a lesion(s) of most stress or injured tissue in inspection process steps 200. This lesion is found at musculotendinous junction of pectoralis muscle. Transverse friction massage is performed for 10-15 minutes on damaged tissue

Joint Mobilization—Step 320

1. Necessary shoulder joint mobilizations are administered to clear any improper joint mobility prior to the inhibition step. Posterior and inferior mobilizations are done.

Decreasing Active Stiffness of Over-Facilitated Tissue—Step 330

1. Patient's arm is brought into extension/abduction in plane of maximal restriction (most tight) to end range of motion

2. Patient contracts against resistance for 5-15 seconds

3. Following the patient actively tries to bring their arm back into the restricted position as far as possible with some assistance to reach a new end range

4. Patient then is instructed to hold and resist the doctor pulling the arm anteriorly for 5-15 seconds

5. This pattern is repeated until the arm gains a new end range of mobility without a restricted feeling AND the patient's strength to hold against anterior pull reaches fully restored strength.

Decreasing any remaining passive stiffness. Step 340. This step involves the provider applying a sustained firm pressure over the shortened inert tissue with movement into the restricted plane whereby the patient feels or notes a “melting” away of the tissue as it releases.

Increasing Active and Passive Stiffness of Inhibited Tissue—Step 350

1. With shoulder retractors and external rotators placed in shortened position, a deep slow rub will begin to “wake up” the inhibited poster muscles of the shoulder

2. The shoulder retractors and external rotators are placed in a fully lengthened position and the patient is instructed to contract those muscles. The practitioner utilizes a broad contact and a rapid stretch is performed on the tissue with special emphasis at the musculotendinous junction. The procedure will commence once increased tissue tension is noted in the superficial fascia.

3. Once an elicited burn is felt the process progresses to perturbations. With muscle in lengthened position have the patient contact the homogenous muscle group against resistance while delivering quick stroking perturbations along the muscle fibers throughout. Do this until full burn is felt by patient and maximum hypertonicity is noted by clinician.

With the inventive method, patients experience immediate improvement on VAS (subjective pain scores), range of motion, strength, and functional capacity i.e. strength and endurance. Typical treatment, when comparing outcomes, are ¼ to ⅓ as long as known treatment regimens to achieve the same outcomes. Moreover, the method of the present invention eliminates in many cases a need, or the perceived need, for surgical intervention, particularly in the case of low back pain.

### Working Example 2

### Non-Specific Low Back Pain

Transverse Friction Massage is performed on the tissues that has undergone failed adaption i.e. commonly the iliocostalis lumborum. Step 310.

Joint mobilization to affected articulations including the lumbar spine (most commonly utilizing a posterior to anteriorly directed force) hip (most commonly utilizing a flexion as well as internal rotation force) and sacroiliac joint. Step 320.

Decrease active and passive stiffness in the iliocostalis lumborum, quadratus lumborum, iliopsoas, and hamstring. Step 330.

Performing therapeutic procedures on the thoracolumbar fascia, sacral ligaments, and hip capsule to decrease any remaining passive stiffness. Step 340.

Increase active and passive stiffness of inhibited tissue by facilitating the multifidii, glutes maximus, medius, and minimus, rectus abdominus and transverse abdominus. Step 350.

The various embodiments of the present invention may be presented in a computer readable medium, e.g., a computer disk or website, that guides and/or trains the practitioner or healthcare provider through the various treatment steps generally as well as for specific conditions and/or injuries. This alternative may thus be used to guide the provider through treatment of certain conditions and/or injuries to the neuromusculoskeletal system as well as serve as an instructional aid for those providers seeking to learn the underlying techniques and process of the present invention.

Thus, a programmable computer, or a computer capable of accessing the material on the computer readable medium, having a display and keyboard, or other data input device, attached or incorporated therein will be required. The computer will comprise, inter alia, a processor for executing the program and/or the computer readable medium embodying the programmed instructions comprising the present invention's process, and a memory for storage of some or all of the programmed instructions, wherein the memory and processor are in operative communication with each other as well as the computer itself being in operative communication with the keyboard or data input device as well as the display. In addition, the computer may be able to communicate with an external website, available through the internet or a cloud data service, wherein the website serves as the medium through which the present invention's process as a healthcare tool and/or instructional tool may be accessed using the computer.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A method for treating a patient with at least one neuromusculoskeletal condition and/or injury, comprising:
inspecting the patient to identify the tissue associated with and the at least one joint associated with the condition and/or injury;
remodeling the tissue associated with the condition and/or injury;
mobilizing the at least one joint and accessory motions;
decreasing active stiffness of over-facilitated contractile and non-contractile tissue associated with the injury through therapeutic procedures;
decreasing any passive stiffness remaining in the over-facilitated tissue after decreasing the active stiffness in the over-facilitated tissue through therapeutic procedures;
increasing active and passive stiffness of inhibited contractile and non-contractile tissue;
conducting re-education of the neuromusculoskeletal system; and
providing the patient with an active at-home program to prevent recurrence of the condition and/or injury.

2. The method of claim 1, further comprising an active care component.

3. The method of claim 2, wherein the active care component comprises:
reinforcement of proper pre-activity patterns with closed kinetic chain exercises;
improving the patient's strength and endurance; and
assessing the patient's extrinsic functions and modifying where required.

4. The method of claim 1, wherein the remodeling comprises transverse friction massage for a time period within the range of 8 to 15 minutes.

5. The method of claim 4, wherein the transverse friction massage is performed for a time period within the range of 10 to 15 minutes.

6. The method of claim 5, wherein the transverse friction massage is conducted only within the specific tissue associated with the condition and/or injury and in a direction that is perpendicular to the lengths of the organized fibers of the specific tissue.

7. The method of claim 1, wherein the condition and/or injury comprises one of the group consisting of: low-back pain, shoulder pain, knee pain, ankle pain, hip pain, neck pain, and elbow pain.

8. The method of claim 1, wherein the therapeutic procedure for decreasing any passive stiffness remaining in the over-facilitated tissue after decreasing the active stiffness in the over-facilitated tissue comprises applying firm pressure over shortened, inert tissues with movement into the restricted plane until the tissue melts away or releases.

9. A method for a healthcare provider to remodel a patient's tissue associated with a neuromusculoskeletal condition and/or injury, comprising:
inspecting the patient to identify the tissue associated with the condition and/or injury; and
remodeling the tissue associated with the condition and/or injury wherein the remodeling comprises massaging all levels of fiber within the tissue associated the condition and/or injury, wherein the massage is conducted only in a direction that is perpendicular to the lengths of the organized fibers of the specific tissue.

10. The method of claim 9, further comprising conducting the massage for a time period of 8 to 15 minutes.

11. The method of claim 9, further comprising conducting the massage for a time period of 10 to 15 minutes.

12. The method of claim 9, wherein the condition and/or injury comprises one of the group consisting of: low-back pain, shoulder pain, knee pain, ankle pain, hip pain, neck pain, and elbow pain.

13. A method of creating and maintaining balance within tissues associated with a neuromusculoskeletal system injury, comprising:
identifying the over-facilitated contractile and non-contractile tissue;
identifying the inhibited tissue;
decreasing the active stiffness of the over-facilitated tissue through therapeutic procedures;
decreasing any remaining passive stiffness remaining after the decreasing of the active stiffness of the over-facilitated tissue through therapeutic procedures;
increasing the active and passive stiffness of the inhibited tissue; and
creating balance between the over-facilitated tissue and the inhibited tissue.

14. The method of claim 13, wherein the therapeutic procedures for decreasing any passive stiffness remaining in the over-facilitated tissue after decreasing the active stiffness in the over-facilitated tissue comprises applying firm pressure over shortened, inert tissues with movement into the restricted plane until the tissue melts away or releases.

15. The method of claim 13, wherein the increasing of the active and passive stiffness of the inhibited tissue further comprises a massaging of the inhibited tissue followed by a resisted contraction with perturbations delivered by the provider.

16. The method of claim 13, wherein the condition and/or injury comprises one of the group consisting of: low-back pain, shoulder pain, knee pain, ankle pain, hip pain, neck pain, and elbow pain.

17. The method of claim 12, further comprising an active care component.

18. The method of claim 16, wherein the active care component comprises:
reinforcement of proper pre-activity patterns with closed kinetic chain exercises;
improving the patient's strength and endurance; and
assessing the patient's extrinsic functions and modifying where required.
